(19) United States
(12) Patent Application Publication
(10) Pub. No.: US 2017/0132699 A1
(43) Pub. Date: May 11, 2017

(54) MARKOV DECISION PROCESS-BASED DECISION SUPPORT TOOL FOR FINANCIAL PLANNING, BUDGETING, AND FORECASTING

(71) Applicant: ASTIR TECHNOLOGIES, INC., Shelburne (CA)

(72) Inventor: Donald Hagell, Shelburne (CA)

(73) Assignee: ASTIR TECHNOLOGIES, INC., Shelburne (CA)

(21) Appl. No.: 15/186,811

(22) Filed: Jun. 20, 2016

Related U.S. Application Data
(60) Provisional application No. 62/253,233, filed on Nov. 10, 2015.

(51) Int. Cl. G06Q 40/00

(52) U.S. Cl. CPC G06Q 40/00

(57) ABSTRACT

The present invention provides a computer-implemented method of financial planning, budgeting and forecasting, using a computer-implemented Markov decision process-based model, wherein one or more e input parameters is associated with one or more uncertainty parameters that represent uncertainty in the associated input parameters and at least one of the input parameters is a desired output parameter. The input parameters are processed to generate one or more output parameters, and then the output parameters are re-input and the model re-processed until one or more of the uncertainty parameters is reduced below a pre-set threshold and one of the output parameters matches the desired output parameter. Once the pre-set threshold is reached, the output parameters are used to create a predictive financial plan, budget or forecast that accounts for uncertainty and is presented in a user-readable format.

### FIELD OF THE INVENTION

The present specification relates generally to the economic and financial industries and more specifically to economic and financial planning, budgeting and forecasting that take uncertainty into consideration.

### BACKGROUND OF THE INVENTION

Developing and managing financial resources often entails committing large economic investments over many years with an expectation of receiving corresponding financial benefits in return. Whether a decision yields a gain or loss could well depend upon the strategies and tactics implemented for the financial plan, budget, or forecast. Financial planning, budgeting, and forecasting involve devising and/or selecting strong strategies and tactics that will yield favorable economic results over time.

Financial planning, budgeting, and forecasting may include making decisions regarding the size, timing and investment of capital as well as subsequent reinvestment of financial resources. Key decisions can involve the amount and allocation to and location of operating units as well as timing of new investments. Post-investment decisions may include determining the net cost/benefit or gain/loss across multiple strategic investments. Any one decision or action may have system-wide implications such as propagating positive or negative impact across the financial operations of an organization. In view of the aforementioned aspects of financial planning, budgeting, and forecasting, which are only a representative few of the many decisions facing a manager of financial resources, one can appreciate the value and impact of financial planning, budgeting, and forecasting.

The optimization process of financial planning, budgeting and forecasting can be challenging even under the assumption that the economics and operation of an organization are fully known. Typically, a large number of soft and hard constraints apply to an even larger number of decision variables. In practice, however, there exists uncertainty in planning, budgeting, and forecasting with the economics and/or other components of the decision process, which complicate the optimization process. Accordingly, there is a need for improvement in the art.

### SUMMARY OF THE INVENTION

In accordance with an aspect of the present invention, there is provided a computer-implemented method of financial planning, budgeting and forecasting, the method comprising: receiving one or more input parameters into a computer-implemented Markov decision process-based model, wherein one or more of the one or more input parameters is associated with one or more uncertainty parameters that represent uncertainty in the associated input parameters and at least one of the input parameters is a desired output parameter; processing the one or more input parameters including the associated one or more uncertainty parameters in the computer-implemented Markov decision process-based model to generate one or more output parameters; re-inputting the one or more output parameters into the model and re-processing the model until one or more of the uncertainty parameters is reduced below a pre-set threshold and one of the output parameters matches the desired output parameter; once the preset threshold is reached, using the one or more output parameters to create a predictive financial plan, budget or forecast that accounts for uncertainty in the one or more of the one or more input parameters and generates the desired output parameter; and presenting, in a user-readable format, the predictive financial plan, budget or forecast as a change to one or more of the input parameters required to generate the desired output parameter.

In one general aspect, a method for financial planning, budgeting, and forecasting may include inputting data, wherein an uncertainty space is associated with the inputted data, processing the inputted data with a computer-implemented Markov decision process-based model, and creating a predictive financial plan, budget or forecast according to the uncertainty space associated with the inputted data. Implementations of this aspect may include one or more of the following features. For example, the computer-implemented Markov decision process-based model may include optimizing at least an aspect of the financial plan, budget, or forecast based on the uncertainty space. Inputting data may include receiving known data inputs and uncertain data parameters. The computer-implemented Markov decision process-based model may incorporate the uncertain data parameters. Processing the inputted data with the computer-implemented Markov decision process-based model may include considering the uncertainty space in its entirety. The computer-implemented Markov decision process-based model may include a number of stages, wherein each stage represents a discrete step in time, a number of states within each stage, wherein each state represents a potential state of the financial plan, budget, or forecast, and a number of transition probabilities, wherein each transition probability represents an uncertainty in data. Implementations of this aspect may include one or more of the following features. For example, the transition probabilities may be determined by a current state of the financial plan, budget, or forecast and a future state may be computed from the transition probabilities. A decision-maker may undertake one or more corrective decisions at each of the states to reach a final reward.

In another general aspect, a method for financial planning, budgeting, and forecasting may include inputting data, wherein uncertainty is associated with the inputted data, processing the inputted data with a computer-based optimization model, producing at least a portion of a financial plan, budget or forecast, and executing one or more corrective strategies as the uncertainty unfolds over time. Implementations of this aspect may include one or more of the following features. For example, the computer-based optimization model may incorporate uncertainty. The computer-based optimization model may be a Markov decision process-based model. The uncertainty may be incorporated in the Markov decision process-based model by capturing trade-offs across a plurality of realizations of the uncertainty. Producing at least a portion of the financial plan, budget, or forecast may include achieving a plausible optimization model across an entire uncertain space. Producing at least a portion of the financial plan, budget, or forecast may include using the Markov decision-based model to systematically process uncertain data.

In another general aspect, a method of predictive analytics planning, budgeting, and forecasting financial resources may include receiving data elements to create a financial plan, budget or forecast, wherein a respective generalization of uncertainty is associated with each of the data elements, processing each respective generalization of uncertainty associated with each of the data elements with a computer-implemented Markov decision process-based model, and outputting a recommendation for the strategy to create a financial plan, budget or forecast. Implementations of this aspect may include one or more of the following features. For example, the computer-implemented Markov decision process-based model may incorporate each of the respective generalizations of uncertainty. Processing each respective generalization of uncertainty associated with each of the data elements with the computer-implemented Markov decision process-based model may consist of searching an uncertainty space.

In another general aspect, a computer-based method of optimizing a financial plan, budget, and forecast may include providing input data, wherein the input data incorporates uncertainty, simulating financial planning, budgeting or forecasting using the observation model, generating a first prediction of the financial plan, budget or forecast using the observation model, wherein the first prediction generates first observation output data, generating an estimation model for financial planning, budgeting or forecasting using the input data and the first observation output data, wherein the estimation model generates a prediction, optimizing a financial planning, budgeting or forecasting model using the input data and the estimation model, wherein the financial planning, budgeting or forecasting model consists of a computer-implemented Markov decision process-based model, simulating financial planning, budgeting or forecasting using the observation model and the first observation output data, generating a second prediction of the financial plan, budget or forecast using the observation model and the first observation output data, wherein the second prediction generates second observation output data, comparing the second observation output data with the prediction generated by the estimation model until the second observation output data is substantially consistent with the prediction, and generating a final financial plan, budget or forecast. Implementations of this aspect may include one or more of the following features. For example, the computer-implemented Markov process-based model may include a solutions routine to assist with the optimization of the financial plan, budget, or forecast.

In another general aspect, a method of producing financial plans, budgets, or forecasts from a collection of financial data may include generating a financial planning, budgeting, or forecasting system with input data, optimizing the financial planning, budgeting, or forecasting system according to an uncertainty space, wherein optimizing the system consists of using a computer-implemented Markov decision process-based model, gathering output data generated from the optimization of the system, generating predictions according to the output data, and producing financial plans, budgets, or forecasts using the predictions. Implementations of this aspect may include one or more of the following features. For example, the input data may include deterministic components and non-deterministic components. Optimizing the system according to the uncertainty space may include considering each of the non-deterministic components with the computer-implemented Markov decision process-based model. The computer-implemented Markov decision process-based model may incorporate uncertainty of the input data. The uncertainty space may specify inherent uncertainty of the input data. The financial planning, budgeting, and forecasting system may include the computer-implemented Markov decision process-based model containing an estimation model and an observation model for financial planning, budgeting, or forecasting. The observation model may accept one or more parameter input data from the computer-implemented Markov decision process-based model and provide one or more financial planning, budgeting, or forecasting property input data to the computer-implemented Markov decision process-based model. The financial planning, budgeting, and forecasting system may be optimized by predicting the financial plan, budget, or forecast using the observation model, predicting the financial plan, budget, or forecast using the estimation model, and predicting the financial plan, budget, or forecast using an optimization model, wherein an optimal prediction is realized when the observation model is substantially consistent with the estimation model.

The discussion for decision support tools for financial planning, budgeting, and forecasting presented in this summary is for illustration purposes only. Various aspects of the present invention may only be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

Reference will now be made to the accompanying drawings which show, by way of example only, embodiments of the invention, and how they may be carried into effect, and in which:

FIG. 1 is an illustration of a Markov decision process-based model representing uncertainty associated with data for a financial model resolved in several steps and a solution of the uncertainty over time in accordance with exemplary embodiments of the present invention.

FIG. 2 is an illustration of a two-dimensional financial model, including a heat map that defines a plurality of nodes in accordance with exemplary embodiments of the present invention.

FIG. 3 is a flowchart illustration of a financial simulator for simulating the operation of the financial model of FIG. 2 in accordance with exemplary embodiments of the present invention.

FIG. 4 is a graph representing a discrete probability distribution for uncertain market-share profiles for an organization in accordance with exemplary embodiments of the present invention.

FIG. 5 is a graph representing market-share price ratios for three possible price scenarios for an organization in accordance with exemplary embodiments of the present invention.

FIG. 6 is a schematic illustration of a Markov decision process-based financial planning, budgeting, and forecasting system in accordance with certain exemplary embodiments of the present invention.

FIG. 7 is a flowchart illustration of a method for operating the Markov decision process-based financial planning, budgeting, and forecasting system of FIG. 6 in accordance with certain exemplary embodiments of the present invention.

FIG. 8 is a graph illustration of a specific use case example model of a Markov decision process-based financial planning, budgeting, and forecasting model of FIG. 1 in accordance with certain exemplary embodiments of the present invention.

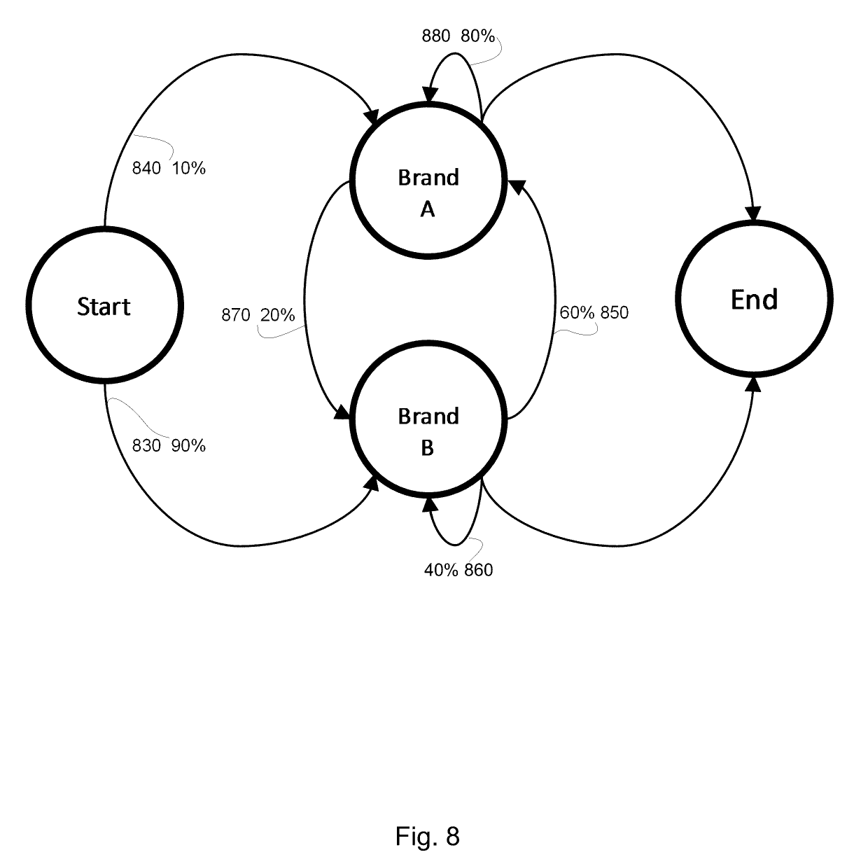

Many aspects of the present invention can be better understood with reference to the above drawings. The elements and features shown in the drawings are not necessarily to scale. Instead, emphasis is being placed upon clearly illustrating principles of exemplary embodiments of the present invention. Moreover, certain dimensions may be exaggerated to help visualize and convey such principles. In the drawings, like reference numerals indicate like or corresponding elements throughout the several views.

### DETAILED DESCRIPTION OF THE EMBODIMENTS

Computer-based modeling holds significant potential for improving financial planning, budgeting, and forecasting, particularly when combined with advanced mathematical techniques. Computer-based planning, budgeting, and forecasting tools may support making good strategic decisions. One type of planning, budgeting, and forecasting tool includes a methodology for identifying an optimal solution to a set of decisions based on processing a multitude of information inputs. For example, an optimization model may work towards finding solutions that yield the best outcome from known possibilities with a defined set of constraints (model-based). Accordingly, an organization may achieve economic benefits by strategically applying optimization models for optimizing financial plans, budgets, and forecasts as well as management of financial assets, particularly those involving a multitude of uncertain decisions over many forecasting periods.

The terms “optimal”, “optimizing”, “optimize”, “optimally” and “optimization” (as well as derivatives and other forms of those terms and linguistically-related words and phrases), as used herein, are not intended to be limited to the single absolute best decision each and every time. Although a mathematically optimal solution may in fact arrive at the best of all mathematically available possibilities, real-world demonstrations of optimization routines, methods, models, and processes may work towards such a goal without ever actually achieving perfection. Accordingly, a person of ordinary skill in the art having the benefit of the present disclosure will appreciate that these terms, in the context of the scope of the present invention, are more general. The terms can describe working towards a solution which may be the best available solution, a preferred solution, a solution that offers a specific benefit within a range of constraints, or continually improving, refining or searching for an optimal point or a maximum for an objective, or processing to minimize a cost function, etc.

In certain example demonstrations, an optimization model can be an algebraic system of functions and equations comprising (1) decision variables of either continuous or discrete variety which may be limited to specific domain ranges, (2) constrained equations, which are based on input data (parameters) and decision variables that restrict activity of these variables within a specified set of conditions that define feasibility of the optimization problem being addressed, and/or (3) an objective function based on input data (parameters) and decision variables being optimized, either by maximizing the objective function or minimizing the objective function. In some variations, optimization models may include non-differentiable, black-box, and other non-algebraic functions or equations.

A typical deterministic mathematical optimization problem involves maximizing or minimizing some objective function subject to a set of constraints on problem variables. These problems can often be formulated as a Dynamic Programming (DP) problem. In a DP problem, decision time horizon is partitioned into a set of “stages” and the system exists in one of several “states”. It may be helpful to visualize the DP problem as an X-Y coordinate system, where the x-axis is represented by the “stages” and the y-axis is represented by the “states”. At each “stage”, the decision-maker takes an “action”, “policy”, or decision, which results in the system transitioning from one “state” at one “stage” to a different “state” in the next “stage”. In one type of DP problem, the objective function can be minimized to determine expense or maximized to determine revenue over the entire planning horizon. Before the system transitions, a revenue/expense is realized at each stage based upon the chosen decision and on the current state. It is assumed that the cost function is separable across each stage and that the system is Markovian, i.e., the state to which the system transitions in stage k+1 depends only on its state in stage k and the action taken in stage k.

A dynamic program can be represented as (S, A, R) where S is the state space, A(s) is the set of actions that can be taken in the state s, and R(s, a) is the reward for choosing action a in state s. The dynamic program is formulated as a recursive optimization problem as shown below:

Vₖ(s):=max[R(s,a)+Vₖ₊₁×T(s,a)]

Vₖ(s)=max[R(s,a)+Vₖ₊₁*T(s,a)] for k=0,1,2,3 . . . k
Where
Vₖ(s)=optimal value function in stage k given state s
R(s, a)=reward for choosing action a in state s
T(s, a)=transition function that determines state in stage k+1 given that the system is in state s in stage k and action a, is chosen.

The final goal reward Rₖ(s), is assumed to be known. The goal of the dynamic program is to find V₀(s₀) where so is the initial state of the system. Dynamic programs may be solved using backward induction when the time horizon is finite. However, when the time horizon is infinite, dynamic programs may be solved using algorithms, such as value/policy iteration.

Solving the problem to mathematical optimality may comprise finding values for the decision variables such that all of the constraints are satisfied, wherein it is essentially mathematically impossible to improve upon the value of the objective function by changing variable values while still remaining feasible with respect to all of the constraints. When some of the “known” fixed parameters of the problem are actually uncertain in practice, a common approach in decision-making is to ignore the uncertainty and model the problem as a deterministic optimization problem. However, the solution to the deterministic optimization problem may be sub-optimal, possible or even infeasible, especially if the problem parameters take values that are ultimately different than those values chosen to be used as input into the optimization model that is solved.

Conventional planning, budgeting, and forecasting technologies often fail to consider such uncertainty within current models. Uncertainty is ordinarily inherent in the information and factors pertinent to financial planning, budgeting, and forecasting. That is, the inputs to the optimization problem (and perhaps mathematically modeling of the problem) contain uncertainty. Uncertainty can be viewed as characteristics or aspects that are nondeterministic or that otherwise remain unknown a priori. Conventional approaches for applying computer programming for decision support in financial planning, budgeting, and forecasting do not take a sufficient accounting of such uncertainty.

Current considerations for uncertainty in financial planning, budgeting, and forecasting combined with the economics and/or other components of the decision process are typically reduced to a very limited number of scenarios such as a “best-case” scenario, a “likely-case” scenario, and a “worst-case” scenario. For instance, the uncertainty in financial planning, budgeting, and forecasting is reduced to a known value for each of the three scenarios mentioned above by typically sampling random points within the uncertainty space. The term “uncertainty space”, as used throughout, generally refers to a representation of uncertainty relevant to a problem that is under solution such as the collective uncertainties for data input to an optimization routine.

Based upon a limited sampling of the uncertainty space, a value is assigned to the “best-case” scenario, the “likely-case” scenario, and the “worst-case” scenario. Decisions are usually optimized for a specific case, usually the “best-case” scenario, and subsequently evaluated for the remaining two scenarios to provide an acceptable level of risk. This approach, however, underestimates the complexity of the uncertainty and may lead to a solution that is sub-optimal or that is less favourable than some other unidentified solution.

In view of the foregoing discussion, need is apparent in the art for an improved tool that can aid financial planning, budgeting, and forecasting and/or that can provide decision support in connection with financial planning, budgeting, or forecasting. A need further exists for a tool that can take broad ranges of uncertainties into consideration for the plans, budgets, or forecasts and for decision support. A need further exists for a tool that systematically addresses uncertain data within a model used to produce financial plans, budgets, or forecasts used for decision support. A need further exists for a tool that can handle a full uncertainty space in connection with producing a financial plan, budget, or forecast used for decision support. A need further exists for a tool in which inherent uncertainty in data is incorporated directly into the decision optimization model where trade-offs associated with decisions across various realizations of the uncertainty are captured and hence, better information is available when making decisions regarding an organization's financial planning, budgeting, and forecasting. The foregoing discussion of need in the art is intended to be representative rather than exhaustive. A technology addressing one or more of such needs, or some other related shortcomings in the field, such as decisions or plans for developing and managing an organization more effectively and more profitably, would benefit financial planning, budgeting, and forecasting.

The present invention supports making decisions, plans, strategies and/or tactics, and/or setting long term policies for organizational financial plans, budgets, or forecasts.

In accordance with one embodiment of the present invention, a computer or software-based method may provide decision support in connection with developing one or more financial plans, budgets, or forecasts. For example, the method may produce a financial plan, budget, or forecast based on input data relevant to the organization and/or operation. Such input may comprise unknown or undefined parameters, economic conditions, profit and loss statements, balance sheets, or cash flow of an organization, to name a few representative possibilities. The input data may have uncertainty. More specifically, each element of input data may have an associated level, amount, or indication of uncertainty. Some of the input data may be known with a high level of uncertainty, such as the current cost of sales, while other input data may have various degrees of uncertainty. For example, future cost of sales may increase as the amount of time projected into the future increases. That is, the uncertainty of cost of sales for the fifth year of the financial plan, budget, or forecast may likely be higher than the uncertainty of cost of sales for the second year. The collective uncertainties of the input data may define an uncertainty space. A software routine may produce the financial plan, budget, or forecast via processing the input data and taking the uncertainty space into consideration by, for example, applying a Markov decision process-based routine. Producing the financial plan, budget, or forecast may, for example, comprise outputting some aspect of a plan, budget, or forecast and making a determination relevant to generating or changing a plan, budget, or forecast or making a recommendation about one or more decisions relevant to financial planning, budgeting, and forecasting.

Exemplary embodiments of the present invention support making decisions regarding financial planning, budgeting, and forecasting while details of uncertain parameters remain unknown. Uncertain parameters unfold over time and decisions may need to be made at regular intervals while incorporating the available information in the decision process. These uncertainties and their evolution over time can be considered directly within an optimization model that may be a Markov decision process-based model, otherwise known as a stochastic dynamic programming model (“SDP”). In an exemplary embodiment, the Markov decision process-based model systematically addresses all of the uncertain data. This uncertainty is represented by transition probabilities that govern transitions between stages, which will be further discussed below. Such a paradigm allows for producing flexible and robust solutions that remain feasible over time covering the uncertainty space as well as making the trade-offs between optimality and the randomness of uncertainty in the input data to reflect the risk attitude of a decision-maker.

The Markov decision process-based model not only incorporates the uncertainty representation to the optimization model and evaluates solution performance explicitly over all scenarios, it also incorporates the flexibility that the decision-maker has in the real world to adjust its decision based on new information obtained over time. The decision-maker will be able to make corrective decisions, actions, policies, and strategies over time based upon this new information. This feature allows for a generation of much more flexible and realistic solutions. Additionally, this model easily incorporates black-box functions for state equations and allows complex conditional transition probabilities to be used.

In certain exemplary embodiments, Markov decision process-based modeling provides an approach to financial planning, budgeting, and forecasting that handles uncertainty effectively. One exemplary embodiment of Markov decision process-based modeling takes advantage of the fact that probability distributions governing financial planning, budgeting, and forecasting data are known or can be estimated. In some embodiments, the Markov decision process-based modeling may be utilized to find a policy that is feasible for all, or nearly all, the possible data instances, as well as maximizes the expectation of some function of the decisions and/or random variables.

The present invention can be embodied in many different forms and should not be construed as limited to the embodiments set forth herein; rather, these embodiments are provided so that this disclosure will be thorough and complete, and willfully convey the scope of the invention to those having skill in the art. Furthermore, all “examples” or “exemplary embodiments” given herein are intended to be non-limiting, and among others supported by representations of the present invention.

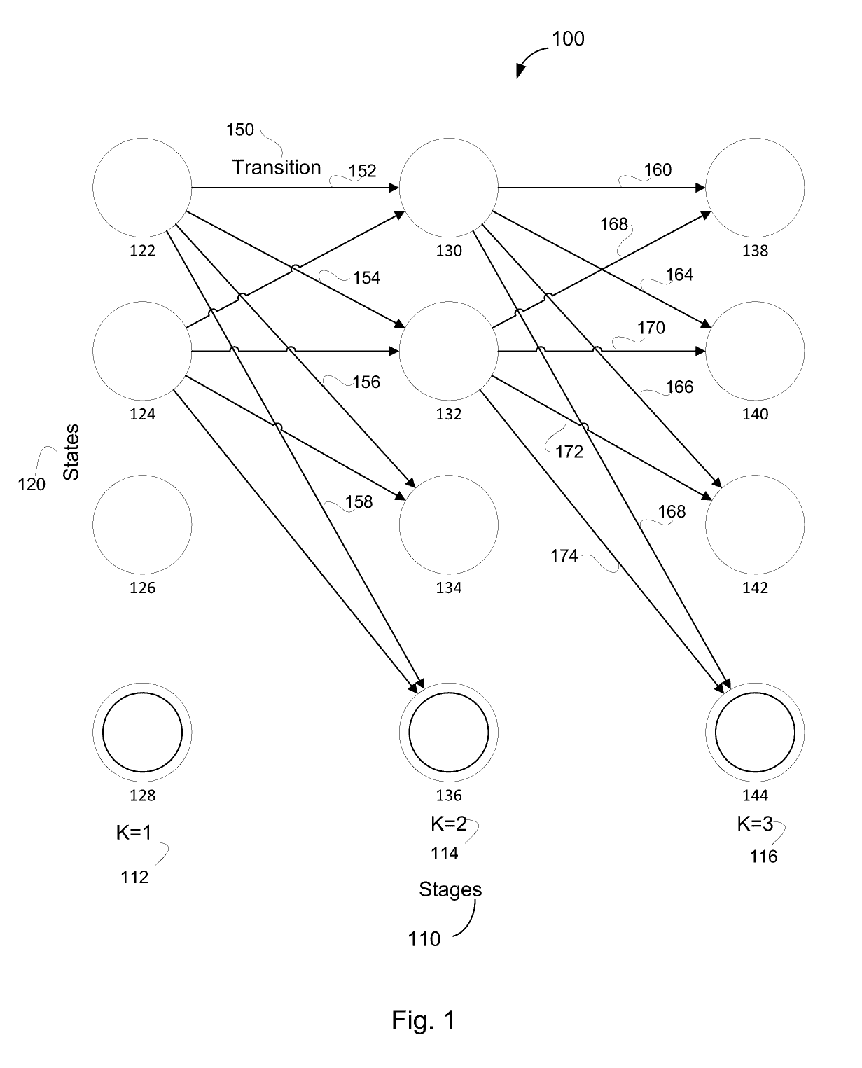

An exemplary embodiment of the present invention will now be described in detail with reference to FIGS. 1 to 6. FIG. 1 is an illustration of a Markov decision process-based model representing uncertainty associated with data for a financial model resolved in several steps and a solution of the uncertainty over time in accordance with exemplary embodiments of the present invention. The Markov decision process-based model 100 illustrates a model with three stages 110 (112, 114, and 116) and four states 120 (122,124,126, and 128) per stage 110. These stages 110 represent the time horizon, the states 120 are used to represent the constraints, the actions (not shown) represent the decision variable, and the transition probabilities 150 are based on data probability distributions. These transition probabilities represent the uncertainty in the data. Although three stages and four states are illustrated in this Markov decision process-based model, any number of stages, states, and actions may be possible without departing from the scope and spirit of the exemplary embodiment.

According to FIG. 1, at stage K=1 112, the system may be in a first state 122, a second state 124, a third state 126, or a fourth state 128. At stage K=2 114, the system may be in a fifth state 130, a sixth state 132, a seventh state 134, or an eighth state 136. At stage K=3 116, the system may be in a ninth state 138, a tenth state 140, an eleventh state 134 based upon a third transition probability 156 or an eighth state 136 based upon a fourth transition probability 158. The transition probabilities 150 are based upon proposed action to be taken. Additionally, the number of transition probabilities is equal to the number of future states at state K=2 114. The transition probabilities may range from 0% to 100%. According to some of the embodiments, the transition probabilities are greater than zero, but less than one hundred.

When the state of the system is at stage K=2 114 and the fifth state 130, the system can transition to the ninth state 138 based upon a fifth transition probability 160, the tenth state 140 based upon a sixth transition probability 162, the eleventh state 142 based upon a seventh transition probability 164, or a twelfth state 144 based upon an eighth transition probability 166. The transition probabilities 150 are based upon the proposed action to be taken. Additionally, the number of transition probabilities is equal to the number of future states at stage K=3 116. The transition probabilities may range from 0% to 100%. According to some of the embodiments, the transition probabilities are greater than zero, but less than one hundred.

However, if the system is at stage K=2 114 and the sixth state 132, the system can transition to the ninth state 138 based upon a ninth transition probability 168, the tenth state 140 based upon a tenth transition probability 170, the eleventh state 142 based upon an eleventh transition probability 172, or a twelfth state 144 based upon a twelfth transition probability 174. The transition probabilities 150 are based upon the proposed action to be taken. Additionally, the number of transition probabilities is equal to the number of future states at stage K=3 116. The transition probabilities may range from 0% to 100%. According to some of the embodiments, the transition probabilities are greater than zero, but less than one hundred.

Thus, according to one embodiment, the decision-makers ultimate reward is to be at stage K=3 116 and the ninth state 138. If the decision-maker is starting at stage K=1 112 and the first state 122, the decision-maker may desire to proceed from the first state 122 at stage T=1 112 to the ninth state 138 at state T=3 116 via the fifth state 130 at stage K=2 114. The decision-maker believes that certain actions will facilitate that progress based upon the transition probability 150, which contains the uncertainties. However, due to the uncertainties, the decision-maker may instead proceed to the sixth state 132 at stage K=2 114 from the first state 122 at stage K=2 112. At the sixth state 132, stage K=2 114, the decision-maker may undertake corrective actions so that the decision-maker may attempt to proceed to the ninth state 138 at stage K=3 116. Although two examples have been provided for reaching the ninth state 138 at stage K=3 116, many pathways may be available for reaching the final reward, ninth state 138 at stage K=3 116, without departing from the scope and spirit of the exemplary embodiment. Additionally, although the final reward has been described to be the ninth state 138 at stage K=3 116, the final reward may be any other state at any future state without departing from the scope and spirit of the exemplary embodiment. Furthermore, although it has been shown that the first state 122 may progress to the ninth state 138, any initial state at stage K=1 112 may progress to any final state at stage K=3 116 based upon the actions taken and the transition probabilities.

The application of a Markov decision process-based model under uncertainty may include long-term planning of investment, labour, or operations in which fixed decisions occur in stages over time. Therefore, opportunities are created to consider more definite information as time passes. Decisions in the model may also include decisions that correspond to actions that may recover information about the uncertainties. Recourse embedded in the Markov decision process-based model allows for the decision-maker to adjust their decision, or undertake corrective actions, based on the information obtained. As used herein, the term “recourse” refers to the ability to take corrective action after a random event has taken place. With recourse leading to robust, flexible, and higher value decisions and a realistic model of decision making in the real world, the Markov decision process-based model provides solutions that are more optimal.

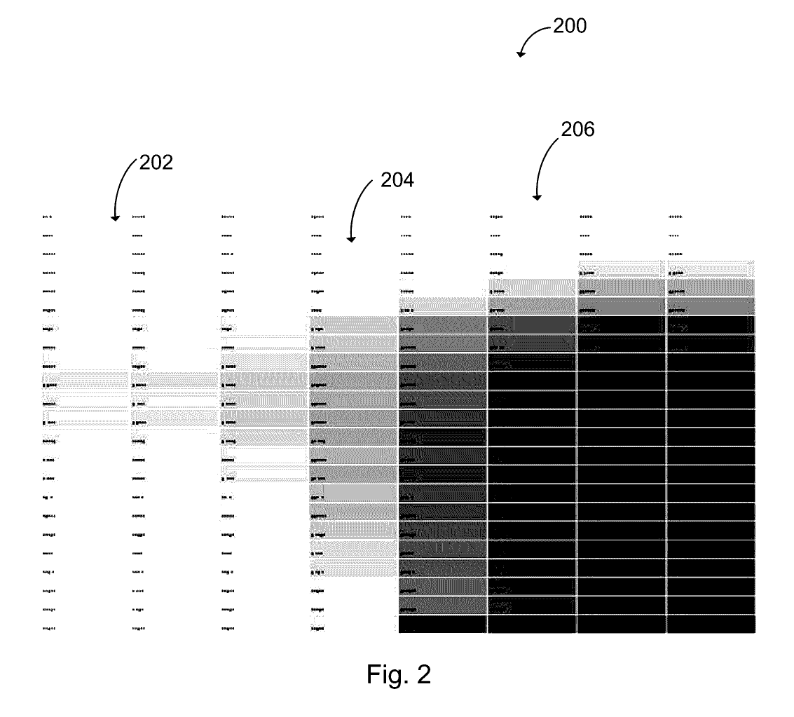

FIG. 2 is an illustration of a two-dimensional financial model 200, including a heat map 206 that defines a plurality of nodes 204 in accordance with certain exemplary embodiments of the present invention. The financial model 200 may be used for simulating the operation of an organization with one or more financial policies 202. As shown, the financial model 200 may be broken up into a plurality of nodes 204 by a heat map 206. The heat map 206 represents an organizational financial policy in cell format to support computer-based processing of financial and organizational information according to the heat map 206. The nodes of 204 of the financial model 200 may be of non-uniform size. This two-dimensional financial model 200 may provide additional data to be used in conjunction with a financial simulator.

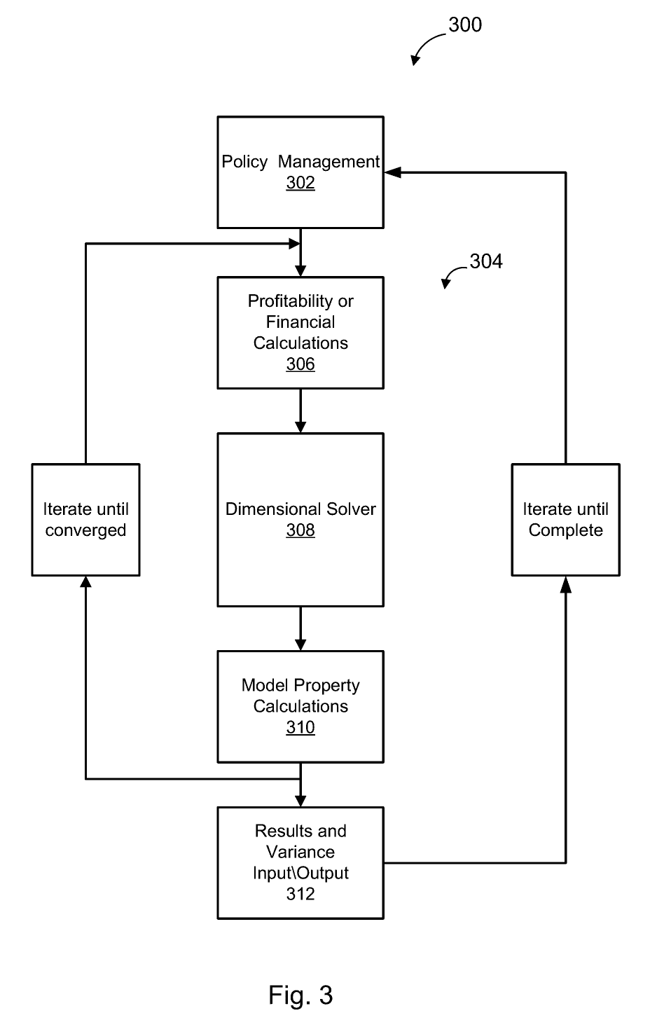

FIG. 3 is a flowchart illustration of a financial simulator 300 for simulating the operation of the financial model 200 of FIG. 2 in accordance with certain exemplary embodiments of the present invention. In an exemplary embodiment, the simulator 300 comprises a set of instructions executing on a computer system. That is, the simulator 300 comprises one or more software programs running on one or more computers. Additionally, the computer may have one or more processors performing the simulation.

Referring to FIG. 2 and FIG. 3, the financial simulator 300 simulates the financial model's operation in which policy management 302 is performed for the policy 202 and the plan, budget, or forecast of the financial model 200. The policy management 302 is performed over all policies 202 in the financial model 200 and includes an iterative process 304 in which a profitability or financial calculation 306 is performed, followed by a dimensional solver 308 and one or more property calculations 310. The dimensional solver 308 and/or one or more model property calculations 310 are performed over large arrays of data that represent properties such as, for example, expected future value at intersecting points in the policy map 206.

Upon completion and convergence of the iterative process 304 for the policy 202 in the financial model 200, the data for the policy 202 is then generated in a results and variance input\output 312. Upon completion of the policy management 302 for the policy 202, the policy management 302 may be performed for the remaining policies 202 of the entire financial model 200, wherein the results of each policy 202 are generated in the results and variance input\output 312.

The financial simulator 300 may be implemented, for example, using one or more general purpose computers, special purpose computers, quantum computers, nondeterministic computers, probabilistic computers, analog processors, digital processors, qubit processors, central processing units, and/or distributed computing systems. That is, the financial simulator 300 can comprise computer executable instructions or code.

The output of the financial model simulator 300 can comprise a result that may be displayed on graphical user interface (GUI), a data file, data on a medium such as an optical or magnetic disk, a paper report, or signals transmitted to another computer or another software routine.

The financial model 200 and the financial simulator 300 may be used to simulate operation of an organization to thereby permit modeling of profitability, revenues, expenses, policies, and related economic indicators. Financial simulation 300 is one part of financial optimization, which also includes constructing the data to accurately represent the finances. An exemplary simulation goal comprises understanding financial patterns in order to optimize some strategy for increasing revenue from some set of policies 202 and economic indicators. The simulation is usually part of a time-consuming, iterative process to reduce uncertainty about a particular financial model description, while optimizing a revenue strategy. Financial simulation, for example, is one kind of computational economic simulation.

The financial model 200 and the financial simulator 300 may further be used to optimize the design and operation of the corresponding organization financial policies and related economic operations.

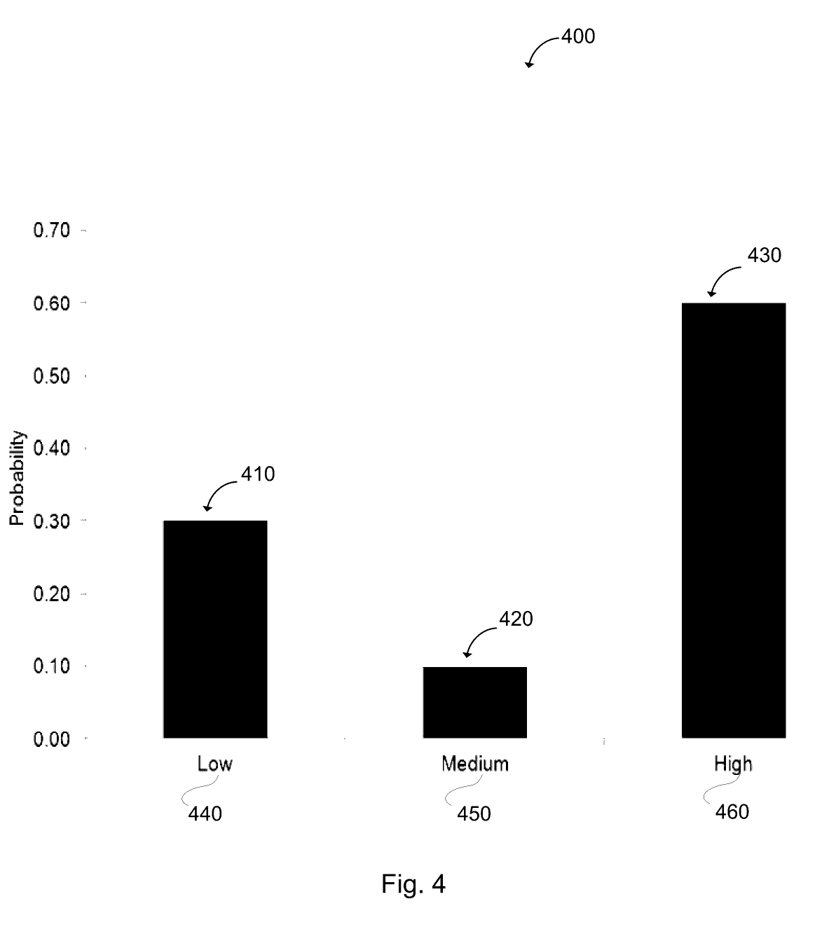

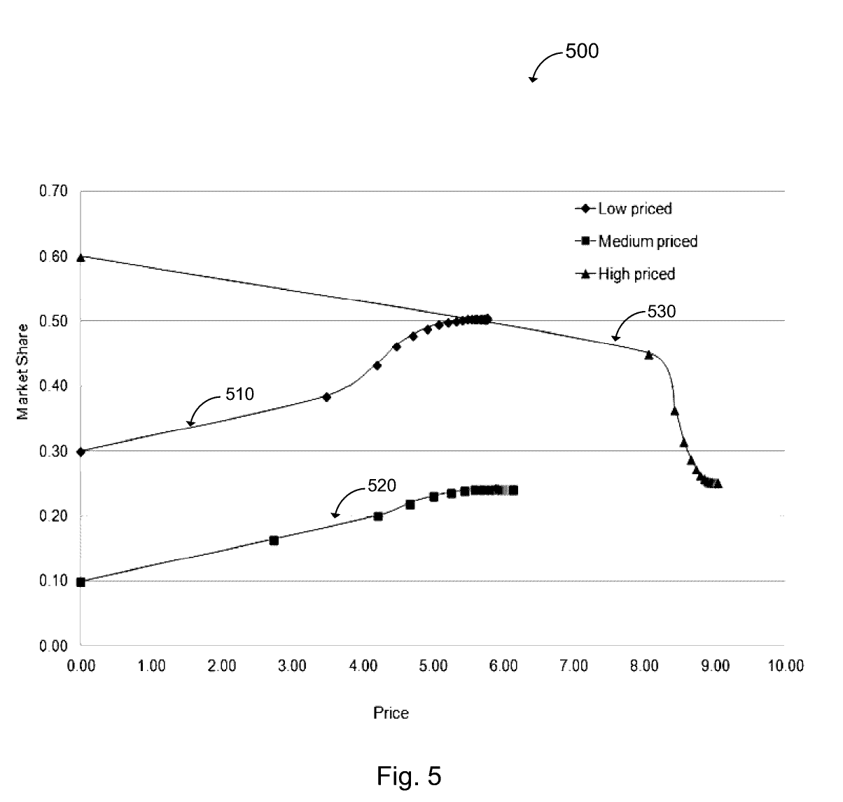

Referring to FIG. 4 and FIG. 5, FIG. 4 is a graph representing a discrete probability distribution for uncertain market-share profiles for an organization in accordance with exemplary embodiments of the present invention and FIG. 5 is a graph representing market-share price ratios for three possible price scenarios for an organization in accordance with exemplary embodiments of the present invention. In the event that the probability distributions are continuous, some form of sampling techniques, including, but not limited to sample average approximations, will be used for discretization of the uncertainty for the model. According to the uncertain market-share profile chart 400 in FIG. 4, the probability of a low-priced scenario 440 is 0.30, or 30 percent, 410. Additionally, the probability of a medium-priced scenario 450 is 0.10, or 10 percent, 420. Furthermore, the probability of a high-priced scenario 460 is 0.60, or 60 percent, 430. FIG. 5 illustrates the three possible market-share price ratio profile scenarios, a low-priced scenario market-share price ratio 510, a medium-priced scenario market-share price ratio 520, and a high-priced scenario market-share price ratio 530, for an organization. Each price ratio profile displays a separate peak for optimization, as well as converging at a different market share percentage. The data shown in the market-share price ratio profile chart 500 is generated using any of the financial simulators.

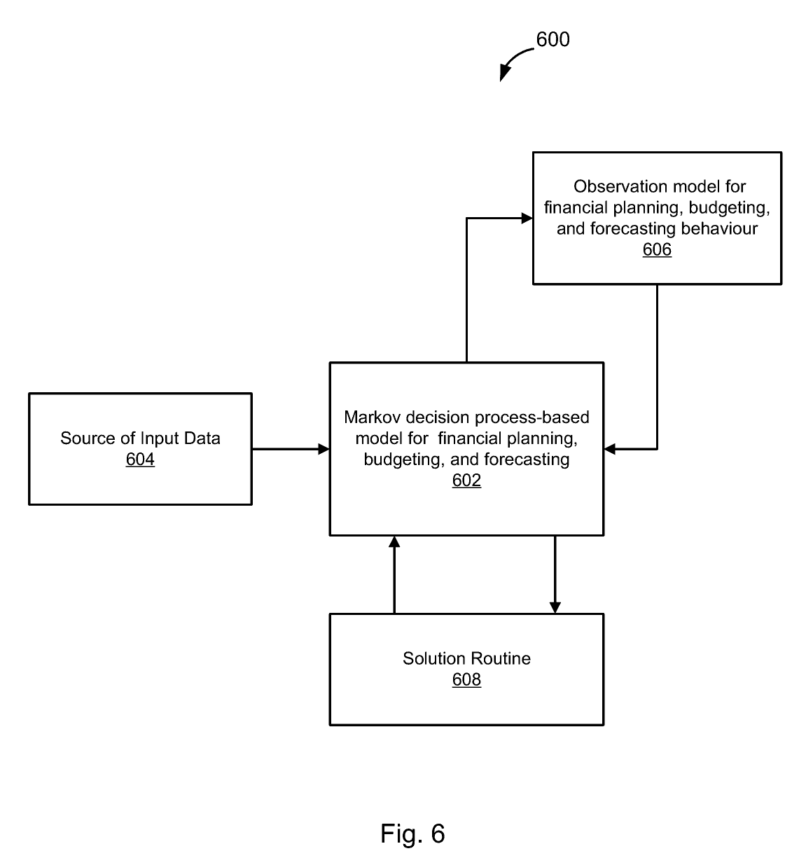

FIG. 6 is a schematic illustration of a Markov decision process-based financial planning, budgeting, and forecasting system 600 in accordance with certain exemplary embodiments of the present invention. In an exemplary embodiment, the financial planning, budgeting, and forecasting system 600 is a computer program, a software-based engine, or a computing module. Moreover, each illustrated block in the diagram of FIG. 6 can comprise a computer program, a software-based engine, or a computing module. Thus, the Markov decision process-based financial planning, budgeting, and forecasting system 600 may be implemented, for example, using one or more general purpose computers, special purpose computers, quantum computers, nondeterministic computers, probabilistic computers, analog processors, digital processors, qubit processors, central processing units, and/or distributed computing systems.

The Markov decision process-based financial planning, budgeting, and forecasting system 600 includes one or more Markov decision process-based models for financial planning, budgeting, and forecasting 602. The Markov decision process-based model for financial planning, budgeting, and forecasting 602 is a Markov decision process-based model for optimizing the financial plan, budget, or forecast given some target objective and subject to the constraints of the system.

Additionally, the Markov decision process-based financial planning, budgeting, and forecasting system 600 may further include at least one source of input data 604, an observation model for financial planning, budgeting, and forecasting behaviour 606 and a solution routine 608. The observation model for financial planning, budgeting, and forecasting behaviour 606 is an observation model, a financial simulation model, or a collection of financial simulation models where each element in the collection represents one possible realization of the uncertainty space. The observation model could also be one financial simulation model that encapsulates the uncertainty. The observation model is used to update and adjust the Markov decision process-based model for financial planning, budgeting, and forecasting 602 in subsequent iterations. Such updates and adjustments provide refinement as the Markov decision process-based model for financial planning, budgeting, and forecasting 602 may contain an approximation of the observation model for financial planning, budgeting, and forecasting behaviour 606 within its system of constraint equations. An estimation model, which is included within the Markov decision process-based model for financial planning, budgeting, and forecasting 602, provides the approximation of the observation model for financial planning, budgeting, and forecasting behavior 606. Similar to the case of the observation model, the estimation model could be a collection of individual estimation models. Alternatively, the estimation model could exist as an individual model that encapsulates the uncertainty. Although two forms have been enumerated in the exemplary embodiment for each of the observation model and the estimation model, additional forms and combinations are contemplated for each of these models without departing from the scope and spirit of the exemplary embodiment.

The Markov decision process-based model for financial planning, budgeting, and forecasting 602 may receive input data from a source of input data 604. The input data can comprise data entities in one or more spreadsheets, or one or more databases, and information fed over a computer network, internet, manual entries, user input from a GUI, etc.

After processing the input data, the Markov decision process-based model for financial planning, budgeting, and forecasting 602 may provide output to the observation model for financial planning, budgeting, and forecasting behaviour 606 of the organization under consideration. The observation model for financial planning, budgeting, and forecasting behaviour 606 may in turn provide its output data back to the Markov decision process-based model for financial planning, budgeting, and forecasting 602. Finally, the Markov decision process-based model for financial planning, budgeting, and forecasting 602 may interface with the solution routine 608.

The present exemplary embodiment provides the Markov decision process-based financial planning, budgeting, and forecasting system 600 in which the inherent uncertainty in the data associated with a financial plan, budget, or forecast is incorporated directly into the Markov decision process-based model for financial planning, budgeting, and forecasting 602. By incorporating the uncertainty in the data into the Markov decision process-based model for financial planning, budgeting, and forecasting 602, trade-offs associated with decisions across various realizations of the uncertainty are captured and hence, better information is available when making decisions regarding financial planning, budgeting, or forecasting.

Generally, the Markov decision process-based model may be formulated, solved analytically or numerically, and analyzed in order to provide useful information to the decision-maker. One of the aims of the Markov decision process-based model is to minimize the expected cost or to maximize the expected revenue over the entire planning horizon, wherein uncertainty is incorporated within the model. The Markov decision process-based model, or MDP, is an extension of dynamic programming wherein the uncertainty is incorporated into the optimization model. The Markov decision process-based model is similar to the dynamic programming model except the deterministic transition function is replaced by a transition probability matrix which represents the uncertainty in the system, and the inclusion of a constant discount factor which represents discounted value on future states. This is for a given state and action in stage k, where the state of the system in stage k+1 is modeled probabilistically and is discounted. The Markov decision process-based model can be represented as (S, A, T, R) where S is the state space, A(s) is the set of actions that can be taken in state s, and T(s, a, s′) is the probability that the system will transition from state s to state s′ given action a, and R(s, a) is the reward for choosing action a in state s. A generic formulation for a Markov decision process-based model is shown below:

$${V}_{k + 1} ( s ) := {max}_{a} \{ {\sum }_{{s}^{′}} T ( s , a , {s}^{′} ) ( R ( s , a ) + γ {V}_{k + 1} ( {s}^{′} ) ) \}$$

1. Vₖ₊₁(s)=maxₐ{ΣT(s, a, s′) (R(s, a)+γVₖ₊₁(s′))}
2. Where
3. Vₖ₊₁(s′)=optimal value function in stage k+1 given state s′
4. R(s, a)=reward for choosing action a in state s
5. T(s, a, s′)=transition function that determines state in stage k+1 given that the system is in state s in stage k and action a, is chosen, transitioning to state s′.
6. γ=gamma constant represents a discount factor

A major strength of the Markov decision process-based model is that, unlike most other approaches, this approach provides solutions that allow the decision-maker to take corrective actions as uncertainty unfolds over time.

In an exemplary embodiment, the Markov decision process-based financial planning, budgeting, and forecasting system 600 provides a decision support tool to optimize a risk averse, risk neutral, or risk seeking measure of the objective function (e.g. net present value—NPV) satisfying all business constraints.

In an exemplary embodiment, the Markov decision process-based model for financial planning, budgeting, and forecasting 602 may be data independent mathematical abstraction of the financial model 200 (FIG. 2). The source of input data 604 may provide financial data which may, for example, be stored and retrieved from spreadsheets, databases, manual entry, or otherwise. The observation model for financial planning, budgeting, and forecasting behaviour 606 may include one or more financial simulators such as, for example, the financial simulator 300, which can comprise or be based upon software based tools, programs, or other capabilities such as those marketed by 1) Oracle Corporation under the registered trademark “Essbase” or 2) Microsoft Corporation under the registered trademark “Analysis Services”. Also, the solutions routine 608 may comprise one or more routines, methods, processes, or algorithms for solving the Markov decision process-based model for financial planning, budgeting, and forecasting 602.

In an exemplary embodiment, the design and operation of the Markov decision process-based model for financial planning, budgeting, and forecasting 602 and the solution routine 608 may be combined in whole or in part. Additionally, the design and operation of the Markov decision process-based financial planning, budgeting, and forecasting system 600 may be implemented, for example, using one or more general purpose programmable computers which may, or may not, be distributed within or between one or more communication networks.

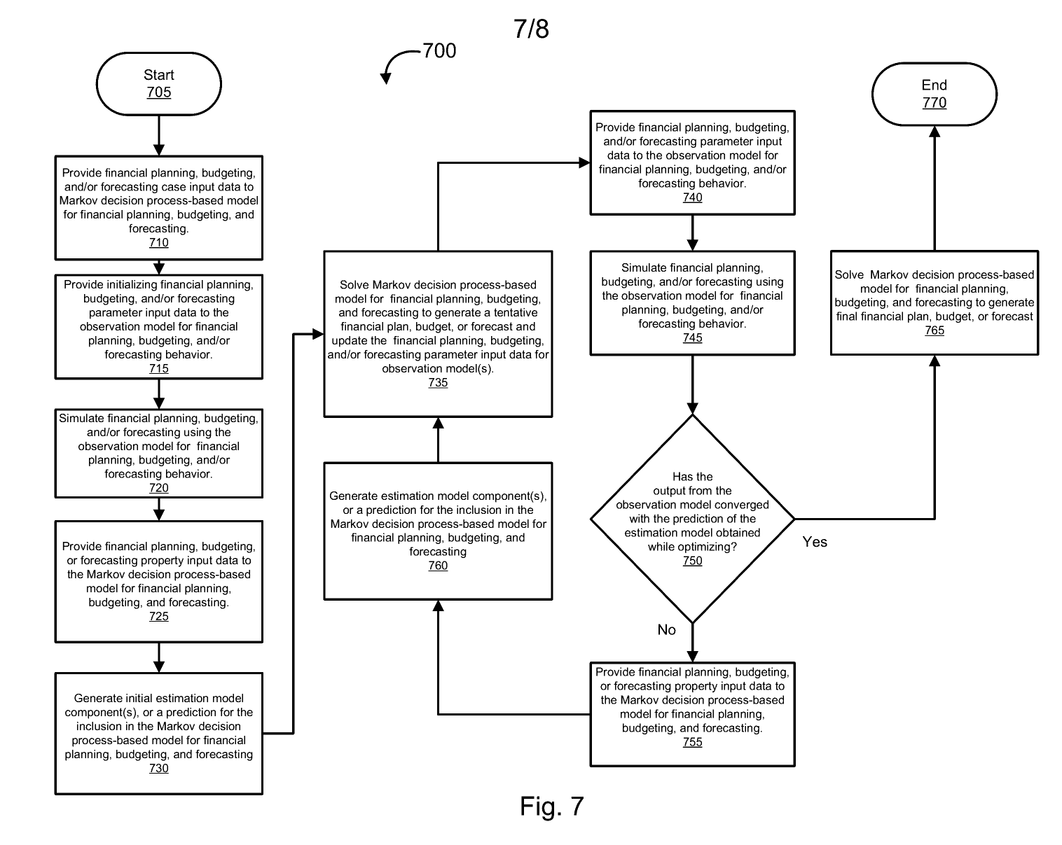

FIG. 7 is a flowchart illustration of a method 700 for operating the Markov decision process-based financial planning, budgeting, and forecasting system of FIG. 6 in accordance with exemplary embodiments of the present invention.

Certain steps in the methods and processes described herein (with reference to FIG. 7 as well as the other figures) may naturally precede others for the present invention to function as described. However, the present invention is not limited to the order of the steps described if such order or sequence does not adversely alter the functionality of the present inventions. That is, it is recognized that some steps may be performed before or after other steps or in parallel with other steps without departing from the spirit of the present invention.

The present invention can include multiple processes that can be implemented with a computer and/or manual operation. The present invention can comprise one or more computer programs that embody certain functions described herein and illustrated in the examples, diagrams, figures, and flowcharts. However, it should not be apparent that there could be many different ways of implementing aspects of the present invention with computer programming, manually, non-computer-based machines, or in a combination of computer and manual implementation. The invention should not be construed as limited to any one set of computer instructions. Further, a programmer with ordinary skill in the art would be able to write such computer programs without difficulty or undue experimentation based on the disclosure and teaching presented herein.

Therefore, disclosure of a particular set of program code instructions is not considered necessary for an adequate understanding of how to make and use the present invention. The inventive functionality of any programming aspects of the present invention will be explained in further detail in the following description in conjunction with the figures illustrating the functions and program flow and processes.

Referring to FIG. 7, the method of operation 700, which will be discussed with exemplary reference to FIGS. 1 to 6, starts at step 705 and proceeds to step 710. At step 710, the financial plan, budget, or forecast case input data is provided to the Markov decision process-based model for financial planning, budgeting, and forecasting 602. The input data may be provided from a combination of manual data entry, spreadsheets, and databases and may include, but is not limited to, specifications of uncertain parameters (e.g. transition probabilities, mode and time of resolution), decision variables (e.g. time when they will be implemented), risk attitude, objective function, etc. These input data may form a data instance that is used to populate one or more mathematical model(s) within the Markov decision process-based model for financial planning, budgeting, and forecasting 602. Furthermore, the input data may include a desired end state or goal, which may be based on other components of the input data, and may be used to test for convergence when determining if the iteration process is complete.

At step 715, the initializing financial planning, budgeting, and forecasting parameter input data is provided to the observation model for financial planning, budgeting, and forecasting behaviour 606.

At step 720, the observation model for financial planning, budgeting, and forecasting behaviour 606 simulates the financial model. This observation model for financial planning, budgeting, and forecasting behaviour 606 may include one or more observation models for financial planning, budgeting, and forecasting behavior such as, for example, financial simulators as discussed above. Additionally, upon performing the simulation, data related to the operation of the financial planning, budgeting, and forecasting model are obtained, wherein the data includes, but is not limited to, revenue estimates, expense, profitability, etc.

At step 725, the simulation results of the financial planning, budgeting, and forecasting model are provided as financial planning, budgeting, and forecasting parameter input data, which may also be referred to as first observation output data, to the Markov decision process-based model for financial planning, budgeting, and forecasting 602.

At step 730, the initial estimation model components are generated for inclusion in the Markov decision process-based model for financial planning, budgeting, and forecasting 602. The initial estimation model components are a prediction for the financial planning, budgeting, and forecasting behaviour. This prediction is generated using the input data and the first maximization output data. The Markov decision process-based model for financial planning, budgeting, and forecasting 602 includes an estimation model that is computationally efficient and provides an approximation of the financial planning, budgeting, and forecasting behaviour. In other words, as compared to the observation model, the estimation model provides less computational precision to produce relatively rough results and thus executes much faster on a typical computing system. The estimation model may be generated from a portion of the software code used in the observation model for financial planning, budgeting, and forecasting behaviour 606. For example, the software of the observation model can be tuned so as to run with less iteration. The observation model may be adapted or configured to provide the estimation model via running two dimensional cross sections, via reducing the number of parameter inputs, via specifying macro state definitions, etc.

Upon completion of steps 705 to 730, the Markov decision process-based model for financial planning, budgeting, and forecasting 602 is solved at step 735, utilizing the input data and the estimation model for financial planning, budgeting, and forecasting behavior. The Markov decision process-based model for financial planning, budgeting, and forecasting 602 can be solved using one or more fit-for-purpose solution routines that may be provided in the one or more of the Markov decision process-based models for financial planning, budgeting, and forecasting 602 and the solution routine 608. The fit-for-purpose solution routines may include a combination of commercial or openly available solver routines and specially designed model-specific techniques. The solving of the Markov decision process-based model for financial planning, budgeting, and forecasting 602 generates a financial model solution, wherein a tentative plan, budget, or forecast and planning, budgeting, and/or forecasting parameter input data, which may also be referred to as financial planning, budgeting, and forecasting output data, for the observation model for financial planning, budgeting, and forecasting behaviour 606 may be generated based on this financial model solution.

At step 740, financial planning, budgeting, and/or forecasting parameter input data, generated by the solving of the Markov decision process-based model for financial planning, budgeting, and forecasting 602, is provided to the observation model for financial planning, budgeting, and forecasting behaviour 606.

At step 745, the observation model for financial planning, budgeting, and forecasting behaviour 606 again simulates the financial plan, budget, and/or forecast. This simulation generates a corresponding observation output data, which may also be referred to as the financial planning, budgeting, and forecasting property input data.

At step 750, a determination is made as to whether the output of the observation model is substantially consistent with the prediction from the estimation model. If the components are not substantially consistent, the financial planning, budgeting, and/or forecasting property input data is again provided to Markov decision process-based model for financial planning, budgeting, and forecasting 602 at step 755. At step 760, the estimation model components are again generated for inclusion into the Markov decision process-based model for financial planning, budgeting, and forecasting 602.

At step 735, the Markov decision process-based model for financial planning, budgeting, and forecasting 602 is again solved. This process continues to iterate until the output of the observation model is substantially consistent with the prediction from the estimation model at step 750. For example, when the results of the estimation model and the observation model converge, step 750 can make a determination that a sufficient level of processing has been completed. At that point, step 750 deems the iterating complete.

The number and time required for iterations is dependent on the number of parameters and variables in the input data, as well as the complexity of the estimation model and the overall degree of uncertainty. For the examples herein, a relatively low number, on the order of tens of iterations, may be required. For more advanced models, the number of required iterations may run to the thousands or millions.

Once the prediction from the estimation model is consistent with the output of the observation model for financial planning, budgeting, and forecasting behaviour 606, the Markov decision process-based model for financial planning, budgeting, and forecasting 602 is again solved to generate an output which may include a final financial plan, budget, or forecast at step 765. The output may be used to generate reports, calculations, tables, figures, charts, etc. for the analysis of financial planning, budgeting, or forecasting under data uncertainty. Moreover, exemplary embodiments of the output comprise a result displayed on a graphical user interface (GUI), a data file, data on a medium such as an optical or magnetic disk, a paper report, signals transmitted to another computer or another software routine, or some other tangible output, to name a few examples.

According to some embodiments, multiple cases may be tested and optimized so that their results may be compared side-by-side as part of the process. The method of operation 700 ends at step 770. Although the method of operation 700 has been illustrated in steps, some of the steps may be performed in a different order without departing from the scope and spirit of the exemplary embodiment.

In various exemplary embodiments, the method 700 can be implemented using a mathematical programming language or system such as, for example, R or Excel, or computer programming language such as, for example, C++, Java or Python, or relational database system, or hierarchical database system, or graph database system, or some combination of any. The fit-for-purpose solution routines may be developed in either mathematical programming languages or directly with a computer programming language or with support of commercially available software tools. For example, commercial and open source versions of mathematical programming language and computer programming language code compilers, relational and hierarchical database management systems are generally available.

General Use Case Example:

Solution Steps:

Create an MDP-based model with (S)tates for each of the data input parameters represented by the data.
1) Input data parameter (Revenue, Expense, Profit, Loss)
2) Calculated forecast drivers for example (Year over year growth %)

Create (A)ctions or transitions in the model represented by the policies or events that can occur. Create policies for the model based on actionable conditions. Create actions based on driver or data classifications which can be measured in time shifts as uncertainty unfolds over time.
1) Planners Expectations (Best, Expected, Worst Case)
2) Strategic Policies (Increase, Maintain, Decrease a Ratio)
3) Forecast Drivers (GDP, Weather, other drivers of uncertainty) [e.g. GDP: Expansion, Contraction, Recession, Depression, Recovery]

Calculate or Input (T)ransition probabilities for each transition of (S)tates and (A)ctions. This creates a transition probability matrix using a Switching methodology. These can be computed using a variety of methods including statistical, standard deviations, Bayesian, and probability distribution functions (PDF).

$$1 ) NonSwitching \% = T ( state , action ) = 1 - ( \frac{StDev ( input data ( state , action ) )}{Max ( input data ( state , action ) )} ) \\ 2 ) Switching \% = T ( state , action ) = ( 1 - NonSwitching \% ) * ( \frac{Next State \%}{1 - State \%} )$$

Input the (R)eward case data in the form of goals and economic rewards at each time step. During simulation, for each state calculate the delta at each time step.
1) Enter (R)eward or Goal input parameters for each of the data and forecast driver states.
2) Reward=Past State—Present State

$$3 ) Reward \% = \frac{Past State - Present State}{Past State}$$

In operation the objective is to maximize profitability. The method involves alternating the usage of bellman equations, value iterations, policy extraction, and q-update to produce a forecast. The following is a pseudo-code representation of the process.

At each Stage (time steps):
1. Read input data for this stage
2. Perform Q-update for the new data inputs
3. Perform Transition probability update by incorporating new data values into probabilities.
4. Updates forecast drivers and goals (may be sourced externally)
5. Perform Value Iteration until Error less than Delta has converged to produce a first Forecast.
   a) At each step in value iteration, simulate the values for all states and transitions
6. Create a Markov Chain until Error less than Delta has converged to produce a Markov Chain for forecasting.
   a) At each step in the Markov Chain, simulate the probabilities for all states and transitions.
7. Create a second Forecast by Comparing Q-update values Markov Chain probabilities from the first Forecast.
   a) Update forecast drivers based on Q-update until converged with first forecast.
8. Create a third Forecast by using the Q-update forecast drivers from the second forecast and.
9. Calculate drivers and ratios based on Q-values.
10. Perform Policy Extraction to identify the optimal policy. This may be visualized, for example, by creating a Policy Map (heat map style) for a human planner.
11. Planning Agent: Makes recommendation of optimal policy, value, and probability.
12. At this stage, a decision is made external to the model whether to include or update the recommended optimal policy into a fourth Forecast, or to proceed.

Specific Use Case Example:

This following example demonstrates the use of the MDP-based solver can help make intelligent decisions in financial planning. The solver in this example is operating on known (or estimated) market share and customer switching data, with the uncertainty related to the ongoing adjustments.

Thus, Company A currently holds 10% of the market share 830 for a brand of products Brand A 810. A competitive brand of products Brand B 820 from Company B holds the remaining 90% of market share 840. The market share values 830 and 840 represent initial input data.

Company A has information (e.g. from a survey) that given the option of a lower price, 60% of the customers that use competitive Brand B, would switch to or least try Brand A. These are represented as customer switching rates 850 and 860, reflecting the customer decision from the base state. From the same survey and customer loyalty data, it is determined, that Brand A has an 80% customer retention rate, producing customer switching rates 870 and 880, accordingly.

Additionally, there may be one or more assumptions: in this example, it is expected that Company B would strategically counter Company A's advertising campaign and price movements with a maximizing strategy of its own. Therefore, in this example, an aggressive switching model is used to emphasis the movements.

The Goal is reached by using sources of research including customer loyalty, corporate data, purchase habits, surveys, and market research to create brand switching probabilities. Brand switching can be utilized to determine future market share and value of an advertising campaign. Overall goal is to attain a new, higher percentage of market share for Brand A.

In this example, uncertainty arises in respect of what degree changes impact the respective brand shares over time. Within the uncertainty, there is both the brand switching behavior of the consumers, as well as the response (price change) from Company B.

Finally, the outcome is to recommend an initial lower price setting by Brand A to achieve a market share goal within the specified degree of probability.

In this example, the desired output is a percentage of market share. The expected state for this output is arrived at from the price reduction. Therefore, the inputs include, among other variables, current price and current market share. The MDP then iterates over different price reductions states, where each state operates based on the switching parameters without regard for any previous states. When the iteration reaches the level of uncertainty defined with the inputs, e.g. 50%, 66%, 75%, the final output is presented to the user. For example, for a given set of inputs, the initial estimate may be to achieve a goal of 50% market share based on a 20% price reduction. However, once iterated by the MDP, the output from the MDP may recommend a 15% price reduction to achieve 50% market share, with a probability of 75%.

Specific details for implementation of a recommendation may not be provided, as that information is may not found within the inputs, and a recommendation may not be provided without a corresponding input. However, by increasing the number and specificity of inputs, a more detailed recommendation may be provided. In general, limitations may be found in the availability of reliable data for inputs, and the computational power required to iterate more complex inputs and models to achieve an output.

Further, the model can be updated on a recurring basis with new input data and re-iterated to provide an updated recommendation. For example, the model could be re-iterated on a monthly basis, once the corresponding financial data is received. In this manner, the system may account for unexpected events and flawed assumptions by providing updated recommendations to achieve the desired goal.

It is understood that variations may be made in the foregoing without departing from the scope and spirit of the invention. For example, the teachings of the present illustrative embodiments may be used to enhance the computational efficiency of other types of n-dimensional computer models.

Although illustrative embodiments of the present invention have been shown and described, a wide range of modifications, changes and substitutions are contemplated in the foregoing disclosure. In some instances, some features of the present invention may be employed without corresponding use of the other features. Accordingly, it is appropriate that the appending claims be construed broadly and in a manner consistent with the scope and spirit of invention.

1. A computer-implemented method of financial planning, budgeting and forecasting, the method comprising:
receiving one or more input parameters into a computer-implemented Markov decision process-based model, wherein one or more of the one or more input parameters is associated with one or more uncertainty parameters that represent uncertainty in the associated input parameters and at least one of the input parameters is a desired output parameter;
processing the one or more input parameters including the associated one or more uncertainty parameters in the computer-implemented Markov decision process-based model to generate one or more output parameters;
re-inputting the one or more output parameters into the model and re-processing the model until one or more of the uncertainty parameters is reduced below a pre-set threshold and one of the output parameters matches the desired output parameter;
once the preset threshold is reached, using the one or more output parameters to create a predictive financial plan, budget or forecast that accounts for uncertainty in the one or more of the one or more input parameters and generates the desired output parameter; and
presenting, in a user-readable format, the predictive financial plan, budget or forecast as a change to one or more of the input parameters required to generate the desired output parameter.

2. The method of claim 1, wherein the one or more input parameters comprise input parameters that are not associated with any of the one or more uncertainty parameters.

3. The method of claim 1, wherein the one or more uncertainty parameters are input parameters.

4. The method of claim 1, wherein the computer-implemented Markov decision process-based model optimizes at least an aspect of the financial plan, budget or forecast by processing the one or more uncertainty parameters and the aspect is contained in one or more of the input parameters.

5. The method of claim 1, wherein the computer-implemented Markov decision process-based model comprises:
one or more stages which each represent a discrete step in time;
one or more states within each stage, wherein each state represents a potential state of the predictive financial plan, budget, or forecast; and
one or more transition probabilities, wherein each transition probability represents an uncertainty in the associated input parameter.

6. The method of claim 5, wherein the transition probabilities are determined by a current state of the financial plan, budget or forecast and wherein a future state is computed from the transition probabilities.

7. A method of financial planning, budgeting and forecasting, comprising:
receiving one or more input parameters into a computer-implemented Markov decision process-based model, wherein one or more of the one or more input parameters is associated with one or more uncertainty parameters that represent uncertainty in the associated input parameters;
processing the one or more input parameters including the associated one or more uncertainty parameters in the computer-implemented Markov decision process-based model to generate one or more output parameters; and
using the one or more output parameters to create at least a portion of a predictive financial plan, budget or forecast that accounts for uncertainty in the one or more of the one or more input parameters; and
executing one or more corrective strategies as the uncertainty unfolds over time;
wherein the method is processed iteratively until the uncertainty is reduced below a pre-set threshold.

8. A computer-implemented method of optimizing a financial plan, budget or forecast, comprising:
receiving one or more input parameters into a computer-implemented Markov decision process-based model, wherein one or more of the one or more input parameters is associated with one or more uncertainty parameters that represent uncertainty in the associated input parameters;
generating a first prediction of the financial plan, budget or forecast using the observation model, wherein the first prediction generates first observation output data;
generating an estimation model for financial planning, budgeting or forecasting using the one or more parameters and the first observation output data, wherein the estimation model generates a prediction;
optimizing a financial planning, budgeting or forecasting model using the one or more input parameters and the estimation model, wherein the financial planning, budgeting or forecasting model comprises a computer-implemented Markov decision process-based model;
simulating financial planning, budgeting or forecasting using the observation model and the first observation output data;
iteratively generating a further prediction of the financial plan, budget or forecast using the observation model and the first or further observation output data, wherein the further prediction iteratively generates further observation output data, and comparing the further observation output data with the further prediction generated by the estimation model until the further observation output data is substantially consistent with the further prediction and at least one of the uncertainty parameters is reduced below a pre-set threshold; and
using the further observation output data that is substantially consistent with the further prediction to generate a predictive financial plan, budget or forecast.

9. The method of claim 8, wherein the computer-implemented Markov decision process-based model comprises a solutions routine to assist with the optimization of the financial plan, budget or forecast.

10. A computer system for generating financial plans, budgets or forecasts from a collection of financial data, the system comprising:
a first computer server comprising a first processor to execute stored instructions;
one or more modules comprising processor executable code that, when executed by the first processor, causes the first processor to:
receiving one or more input parameters into a computer-implemented Markov decision process-based model, wherein one or more of the one or more input parameters is associated with one or more uncertainty parameters that represent uncertainty in the associated input parameters and at least one of the input parameters is a desired output parameter;
processing the one or more input parameters including the associated one or more uncertainty parameters in the computer-implemented Markov decision process-based model to generate one or more output parameters;
re-inputting the one or more output parameters into the model and re-processing the model until one or more of the uncertainty parameters is reduced below a pre-set threshold and one of the output parameters matches the desired output parameter;
once the preset threshold is reached, using the one or more output parameters to create a predictive financial plan, budget or forecast that accounts for uncertainty in the one or more of the one or more input parameters and generates the desired output parameter; and
presenting, in a user-readable format, the predictive financial plan, budget or forecast as a change to one or more of the input parameters required to generate the desired output parameter.

11. The system of claim 10, further comprising a solution routine for solving the Markov decision process-based model.

12. The system of claim 10, wherein the computer-implemented Markov decision process-based model comprises a solution routine.

13. The system of claim 10, wherein the one or more uncertainty parameters are input parameters.

14. The system of claim 10, further comprising an observation model for financial planning, budgeting or forecasting that interfaces with the computer-implemented Markov decision process-based model.

15. The system of claim 10, wherein the computer-implemented Markov decision process-based model comprises an estimation model for financial planning, budgeting or forecasting.

16. The system of claim 14, wherein the computer-implemented Markov decision process-based model comprises an estimation model for financial planning, budgeting or forecasting.

17. The system of claim 16, wherein processing the one or more input parameters comprises:
simulating a first financial plan, budget or forecast using the observation model;
predicting a second financial plan, budget or forecast using the estimation model; and
generating a third financial plan, budget or forecast using an optimization model, by iteratively simulating further first financial plans, budgets or forecasts using the observation model and further second financial plans, budgets or forecasts using the estimation model, wherein the third financial plan, budget or forecast is the first iterated further first financial plan, budget or forecast that is substantially consistent with the iterated second financial plan, budget or forecast.

18. A computer program product comprising:
a storage medium configured to store computer-readable instructions;
the computer-readable instructions including instructions for causing a processor to:
receiving one or more input parameters into a computer-implemented Markov decision process-based model, wherein one or more of the one or more input parameters is associated with one or more uncertainty parameters that represent uncertainty in the associated input parameters and at least one of the input parameters is a desired output parameter;
processing the one or more input parameters including the associated one or more uncertainty parameters in the computer-implemented Markov decision process-based model to generate one or more output parameters;
re-inputting the one or more output parameters into the model and re-processing the model until one or more of the uncertainty parameters is reduced below a pre-set threshold and one of the output parameters matches the desired output parameter;
once the preset threshold is reached, using the one or more output parameters to create a predictive financial plan, budget or forecast that accounts for uncertainty in the one or more of the one or more input parameters and generates the desired output parameter; and
presenting, in a user-readable format, the predictive financial plan, budget or forecast as a change to one or more of the input parameters required to generate the desired output parameter.

19. The computer program product of claim 18, wherein the computer-readable instructions further comprises computer-readable instructions for execution of an estimation model and an observation model for financial planning, budgeting or forecasting.

20. The computer program product of claim 19, wherein the computer-readable instructions for processing the one or more input parameters comprises computer-readable instructions for:
simulating a first financial plan, budget or forecast using an observation model;
predicting a second financial plan, budget or forecast using an estimation model; and
generating a third financial plan, budget or forecast using an optimization model, by iteratively simulating further first financial plans, budgets or forecasts using the observation model and further second financial plans, budgets or forecasts using the estimation model, wherein the third financial plan, budget or forecast is the first iterated further first financial plan, budget or forecast that is substantially consistent with the iterated second financial plan, budget or forecast.
